(19) United States
(12) Patent Application Publication
(10) Pub. No.: US 2022/0343733 A1
(43) Pub. Date: Oct. 27, 2022

(54) BUILD-A-SLOT FEATURE IN ELECTRONIC GAMING MACHINE

(71) Applicant: IGT, Las Vegas, NV (US)

(72) Inventors: Jon Leupp, Pleasant Hill, CA (US); Babak Namaziyan, San Francisco, CA (US)

(73) Assignee: IGT

(21) Appl. No.: 17/236,249

(22) Filed: Apr. 21, 2021

(51) Int. Cl. G07F 17/32; G07F 17/34

(52) U.S. Cl. CPC G07F 17/3262; G07F 17/34

(57) ABSTRACT

A gaming system can be provided including a processor circuit and a memory coupled to the processor circuit. The memory can include machine-readable instructions that, when executed by the processor circuit, cause the processor circuit to perform operations including displaying, via a graphical interface, a grid of symbols comprising a first set of symbols. The operations can further include determining whether the grid of symbols comprises a first winning combination of symbols. The operations can further include determining an updated grid of symbols comprising a portion of the first set of symbols and a second set of symbols. The operations can further include displaying, via the graphical interface, the updated grid of symbols. The operations can further include determining whether the updated grid of symbols comprises a second winning combination of symbols.

### BACKGROUND

An electronic gaming machines (“EGM”) can provide a wagering game to a player in response to the player placing a wager to activate the wagering game. The EGM can further provide a prize to the player based on the wager and an outcome of the wagering game.

An example of a wagering game includes a slot game in which, in response to receiving a wager from the player, one or more rows of symbols are revealed. A prize can be provided to the player based on the one or more rows of symbols including one or more winning combinations of symbols.

### BRIEF SUMMARY

According to some embodiments, a gaming system includes a processor circuit and a memory coupled to the processor circuit. The memory has machine-readable instructions that, when executed by the processor circuit, cause the processor circuit to perform operations. The operations include displaying, via a graphical interface, a grid of symbols comprising a first set of symbols. The operations further include determining whether the grid of symbols comprises a first winning combination of symbols. The operations further include determining an updated grid of symbols comprising a portion of the first set of symbols and a second set of symbols. The operations further include displaying, via the graphical interface, the updated grid of symbols. The operations further include determining whether the updated grid of symbols comprises a second winning combination of symbols.

According to other embodiments, a computer-implemented method of operating a gaming device includes displaying, to a user and via a display device of the gaming device, a grid of symbols that comprises a first set of symbols. The computer-implemented method further includes receiving a wager from the user. The computer-implemented method further includes displaying, to the user and via the display device of the gaming device, an updated grid of symbols that comprises the first set of symbols and a second set of symbols. The computer-implemented method further includes providing to the user a prize based on the updated grid of symbols comprising a winning combination of symbols.

According to other embodiments, a gaming device includes a display device; a processor circuit; and a memory coupled to the processor circuit. The memory includes machine-readable instructions that, when executed by the processor circuit, cause the processor circuit to perform operations. The operations include determining a first set of symbols in a grid of symbols being displayed on the display device. The operations further include determining a new grid of symbols that comprises a portion of the first set of symbols and a second set of symbols. The operations further include displaying the new grid of symbols on the display device.

### BRIEF DESCRIPTION OF SEVERAL VIEWS OF THE DRAWINGS

FIG. 1 is a schematic block diagram illustrating an example of a network configuration for a plurality of gaming devices according to some embodiments.

FIG. 2A is a perspective view of an example of a gaming device that can be configured according to some embodiments.

FIG. 2B is a schematic block diagram illustrating an example of an electronic configuration for a gaming device according to some embodiments.

FIG. 2C is a schematic block diagram that illustrates an example of various functional modules of a gaming device according to some embodiments.

FIG. 2D is perspective view of an example of a gaming device that can be configured according to some embodiments.

FIG. 2E is a perspective view of an example of a gaming device according to further embodiments.

FIGS. 3-10 are diagrams illustrating examples of different plays of a wagering game having a build-a-slot feature according to some embodiments.

FIGS. 11-12 are diagrams illustrating examples of different plays of another wagering game having a build-a-slot feature according to some embodiments.

FIGS. 13-14B are diagrams illustrating examples of different plays of another wagering game having a build-a-slot feature according to some embodiments.

FIGS. 15-18 are flowcharts illustrating examples of operations of an EGM of providing a wagering game with a build-a-slot feature according to some embodiments.

### DETAILED DESCRIPTION

Embodiments described herein relate to game play features with electronic wagering games, and in particular to a build-a-slot feature in electronic gaming machine electronic wagering games based on adding sets of symbols to an existing grid of symbols in the wagering game, such as in a casino environment, and related devices, systems, and methods.

In some embodiments, in response to receiving a wager from a user of a gaming device, a gaming system displays, on a display device of the gaming device, a graphical interface for a wagering game including a plurality of game symbols arranged in an array (also referred to herein as a grid) of a plurality of lines (also referred to herein as rows and/or sets) of game symbols. At least a portion of the array being based on a previous array displayed by the graphical interface for a previous play (or a previous stage) of the wagering game. Based on the array, a game result for the wagering game is determined, a game award is provided to the user based on the game result indicating a winning game result. In additional or alternative embodiments, subsequent play (or subsequent stages) of the wagering game include generating a new array based on the array. In additional or alternative embodiments, once anew array includes a threshold number of lines, a subsequent array is generated and is not based on previous arrays. These and other aspects will be described in greater detail below.

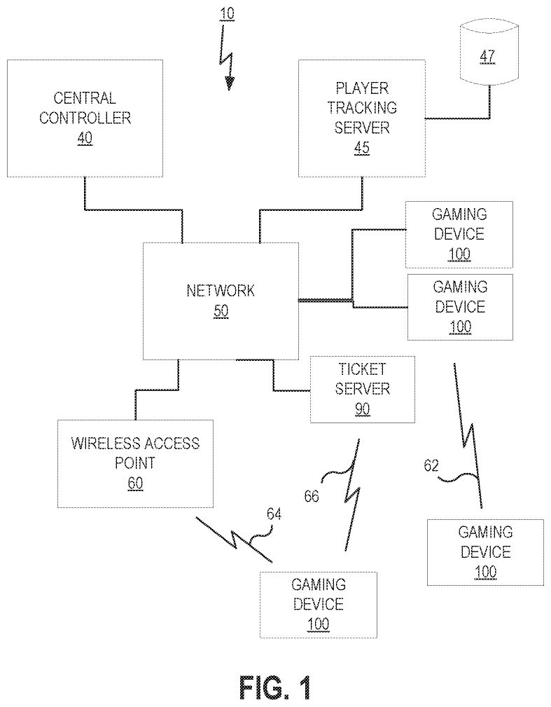

Referring now to FIG. 1, a gaming system 10 including a plurality of gaming devices 100 is illustrated. As discussed above, the gaming devices 100 may be one type of a variety of different types of gaming devices, such as electronic gaming machines (EGMs), mobile gaming devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processing circuit and at least one memory or storage device. Each gaming device 100 may include a processing circuit that transmits and receives events, messages, commands or any other suitable data or signal between the gaming device 100 and the central controller 40. The gaming device processing circuit is operable to execute such communicated events, messages or commands in conjunction with the operation of the gaming device 100. Moreover, the processing circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processing circuits. Moreover, in some embodiments, one or more of the functions of one or more gaming device processing circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processing circuit that transmits and receives events, messages, commands or any other suitable data or signal between the ticket server 90 and the central controller 40. The ticket server 90 processing circuit may be operable to execute such communicated events, messages or commands in conjunction with the operation of the ticket server 90. Moreover, in some embodiments, one or more of the functions of one or more ticket server 90 processing circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, a near field communications (NFC) link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

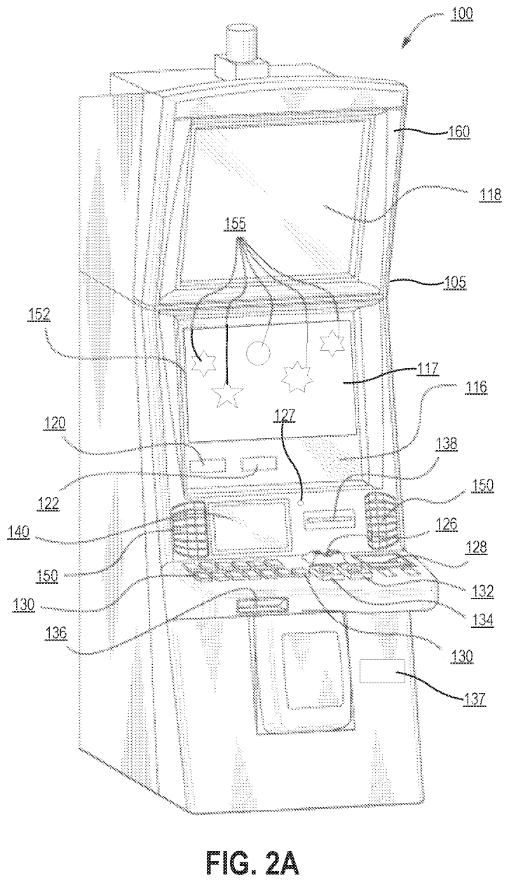

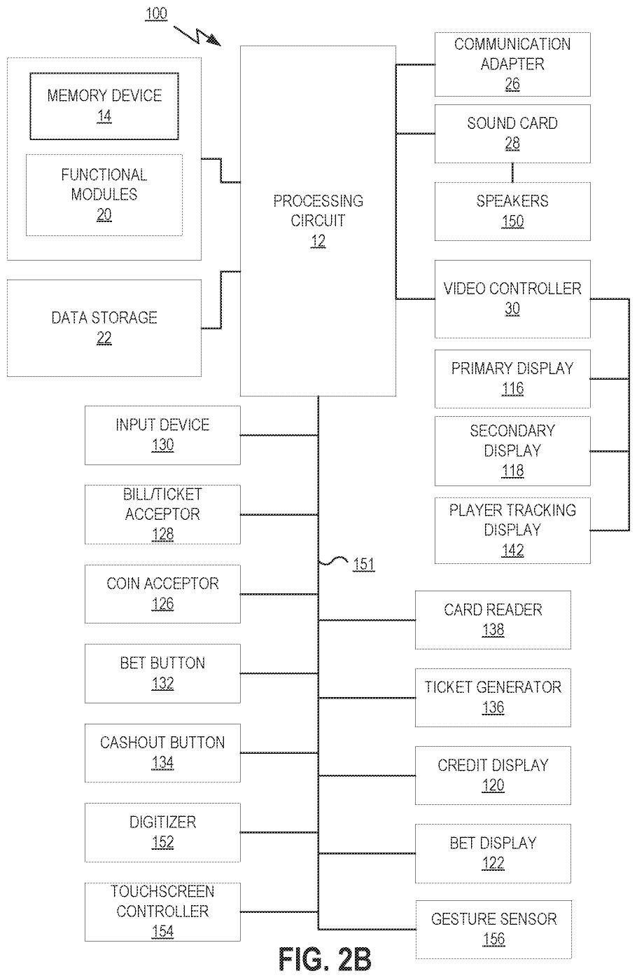

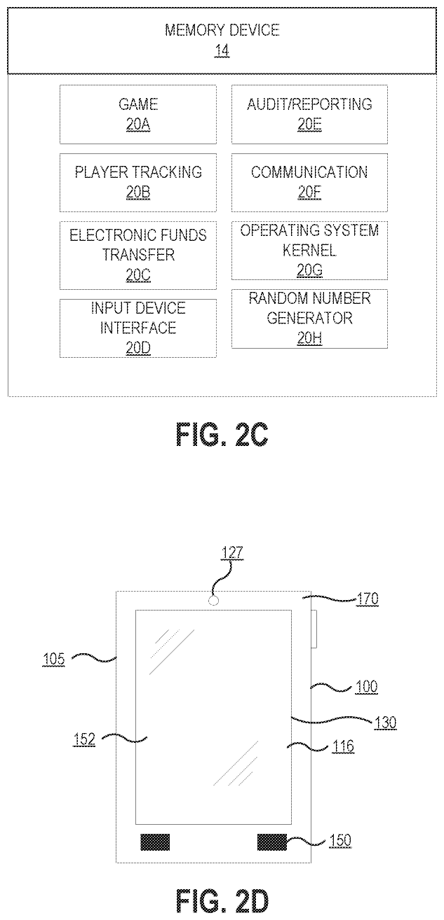

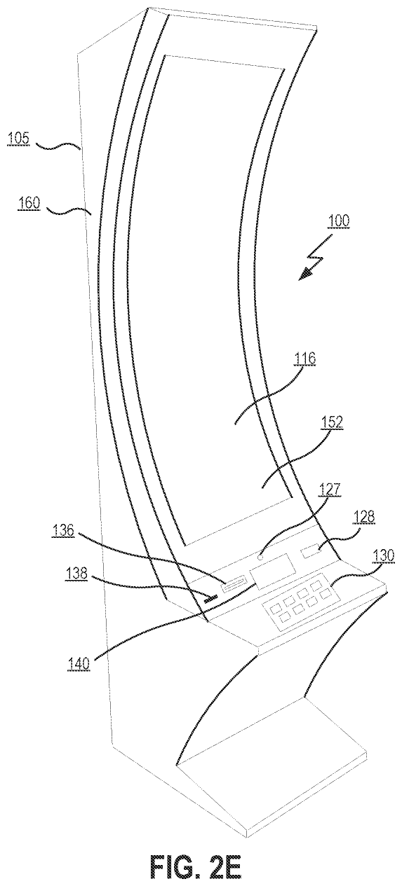

Embodiments herein may include different types of gaming devices. One example of a gaming device includes a gaming device 100 that can use gesture and/or touch-based inputs according to various embodiments is illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A to 2C are provided as examples for illustrative purposes only. It will be appreciated that gaming devices may come in many different shapes, sizes, layouts, form factors, and configurations, and with varying numbers and types of input and output devices, and that embodiments are not limited to the particular gaming device structures described herein.

Gaming devices 100 typically include a number of standard features, many of which are illustrated in FIGS. 2A and 2B. For example, referring to FIG. 2A, a gaming device 100 (which is an EGM 160 in this embodiment) may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIG. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously-placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as gesture sensors 156 for gesture input devices, and/or a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processing circuit 12 or directly from a memory device 14 and displays the video data on the display screen. The credit display 120 and the bet display 122 are typically implemented as simple liquid crystal display (LCD) or light emitting diode (LED) displays that display a number of credits available for wagering and a number of credits being wagered on a particular game. Accordingly, the credit display 120 and the bet display 122 may be driven directly by the processing circuit 12. In some embodiments however, the credit display 120 and/or the bet display 122 may be driven by the video controller 30.

Referring again to FIG. 2A, the display devices 116, 118, 140 may include, without limitation: a cathode ray tube, a plasma display, an LCD, a display based on LEDs, a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touch-screen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images;

images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket dispenser 136, a bill/ticket acceptor 128, and a coin acceptor 126 that allows the player to deposit coins into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processing circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processing circuit 12 that controls operations of the gaming device 100. Although illustrated as a single processing circuit, multiple special purpose and/or general purpose processors and/or processor cores may be provided in the gaming device 100. For example, the gaming device 100 may include one or more of a video processor, a signal processor, a sound processor and/or a communication controller that performs one or more control functions within the gaming device 100. The processing circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processing circuit 12. It will be appreciated that the components may be connected to the processing circuit 12 through a system bus 151, a communication bus and controller, such as a universal serial bus (USB) controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processing circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, DVD or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or NFC that enable the gaming device 100 to communicate, for example, with a mobile communication device operated by a player.

The gaming device 100 may include one or more internal or external communication ports that enable the processing circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, Small Computer System Interface (“SCSI”) ports, solenoids, speakers, thumb drives, ticket readers, touch screens, trackballs, touchpads, wheels, and wireless communication devices. In some embodiments, internal or external peripheral devices may communicate with the processing circuit through a USB hub (not shown) connected to the processing circuit 12.

In some embodiments, the gaming device 100 may include a sensor, such as a camera 127, in communication with the processing circuit 12 (and possibly controlled by the processing circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processing circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

In some embodiments, a gaming device 100 includes a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

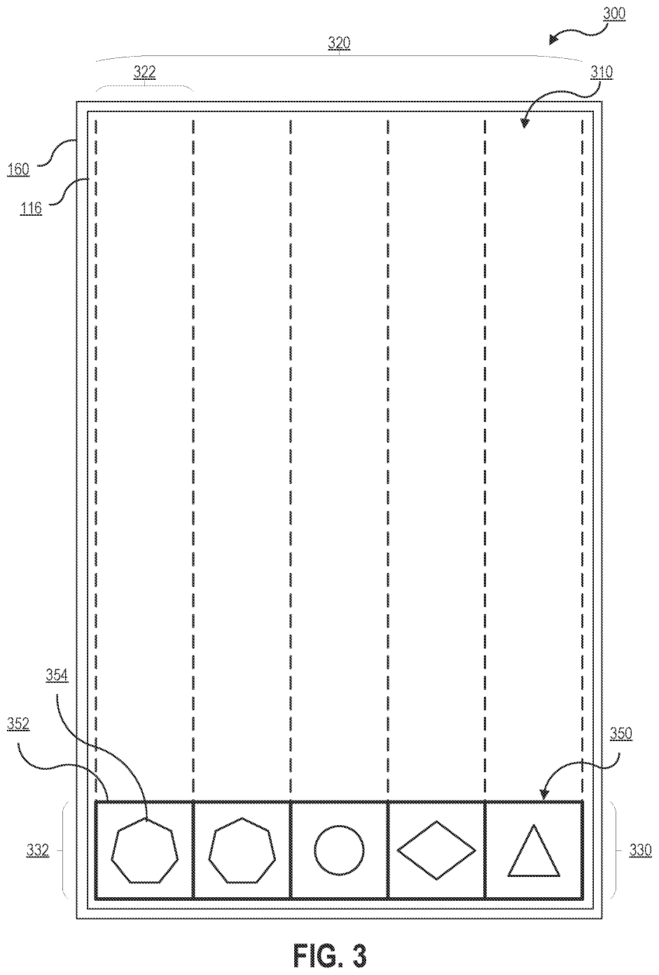

For example, referring to FIG. 2D, a gaming device 100 (which is a mobile gaming device 170 in this embodiment) may be implemented as a handheld device including a compact housing 105 on which is mounted a touchscreen display device 116 including a digitizer 152. As described in greater detail with respect to FIG. 3 below, one or more input devices 130 may be included for providing functionality of for embodiments described herein. A camera 127 may be provided in a front face of the housing 105. The housing 105 may include one or more speakers 150. In the gaming device 100, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100 may omit certain features, such as a bill acceptor, a ticket generator, a coin acceptor or dispenser, a card reader, secondary displays, a bet display, a credit display, etc. Credits can be deposited in or transferred from the gaming device 100 electronically.

FIG. 2E illustrates a standalone gaming device 100 (which is an EGM 160 in this embodiment) having a different form factor from the EGM 160 illustrated in FIG. 2A. In particular, the gaming device 100 is characterized by having a large, high aspect ratio, curved primary display device 116 provided in the housing 105, with no secondary display device. The primary display device 116 may include a digitizer 152 to allow touchscreen interaction with the primary display device 116. The gaming device 100 may further include a player tracking display 142, an input device 130, a bill/ticket acceptor 128, a card reader 138, and a bill/ticket dispenser 136. The gaming device 100 may further include one or more cameras 127 to enable facial recognition and/or motion tracking.

Although illustrated as certain gaming devices, such as electronic gaming machines (EGMs) and mobile gaming devices, functions and/or operations as described herein may also include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

FIGS. 3-10 illustrate an example of an EGM 160 providing a wagering game 300 according to some embodiments. In this embodiment, the EGM 160 includes a display device 116 for displaying a graphical user interface (GUI) 310. In these examples, the wagering game 300 is a slot game that includes the GUI 310 displaying an array 350 (also referred to herein as a grid) defined by columns 320 and rows 330 of slot reels 352 that each have a slot symbol 354 associated with the slot game.

In FIG. 3, the GUI 310 displays a grid 350 that includes a row 332 of slot reels 352 that each have a slot symbol 354. For example, the slot reel 352 in the column 322 of the row 332 includes a slot symbol 354 that is a heptagon. In some embodiments, the grid 350 may not include any winning combination of symbols and, therefore, may not result in any prize being awarded to a player of the wagering game 300.

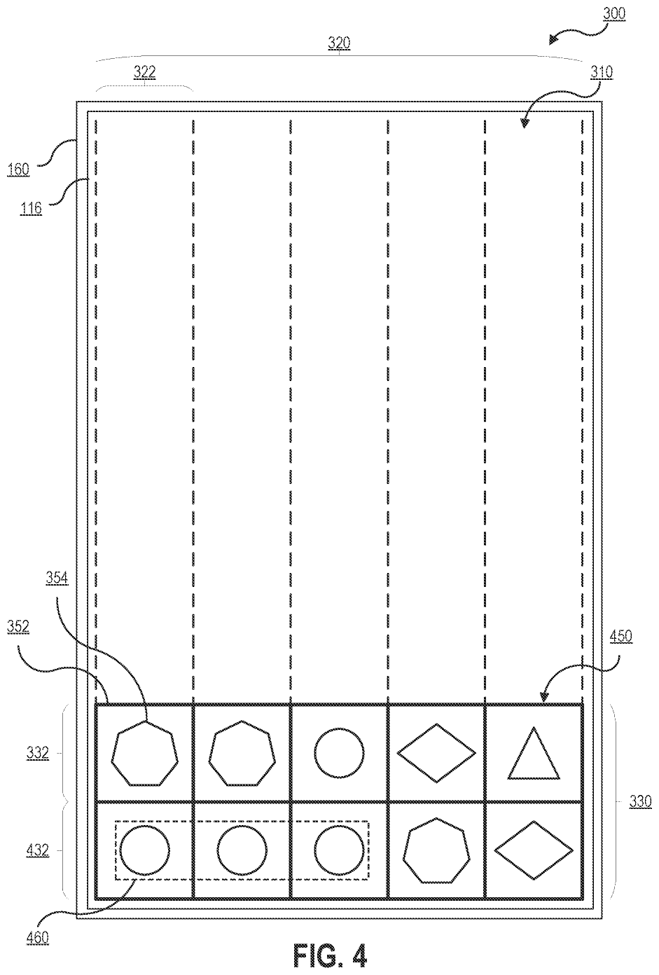

In FIG. 4, the GUI 310 displays a grid 450 that includes row 332 and row 432 that each include slot reels 352 having slot symbols 354. In some embodiments, FIG. 3 illustrates an example of the grid 350 displayed by the GUI 310 during a first play of the wagering game 300 and FIG. 4 illustrates an example of the grid 450 displayed by the GUI 310 during a second play of the wagering game 300. For example, FIG. 3 may illustrate the grid 450 after a user activated the wagering game 300 with a first wager and FIG. 4 may illustrate the grid 450 after the user (or another user) activated the wagering game 300 a second time with a second wager. In additional or alternative embodiments, FIG. 3 illustrates the grid 350 displayed by the GUI 310 during a first stage of the wagering game 300 and FIG. 4 illustrates an example of the grid 450 displayed by the GUI 310 during a second stage of the wagering game 300. For example, FIG. 3 may illustrate the grid 450 a first period of time after a user activated the wagering game 300 with a first wager and FIG. 4 may illustrate the grid 450 a second period of time after the user activated the wagering game with the first wager.

In FIG. 4, row 332 maintains the same slot symbols as previously displayed (e.g., in FIG. 3). In additional or alternative examples, row 332 maintains at least a portion of the same slot symbols 354 as previously displayed (e.g., in FIG. 3). In this example, row 332 is positioned higher in the GUI 310 in FIG. 4 than FIG. 3. In addition, in FIG. 4, row 432 is positioned at the same position within the GUI 310 that row 332 is positioned in FIG. 3. In additional or alternative examples, row 332 may remain in the same position within the GUI 310 and row 432 may be positioned higher in the GUI 310.

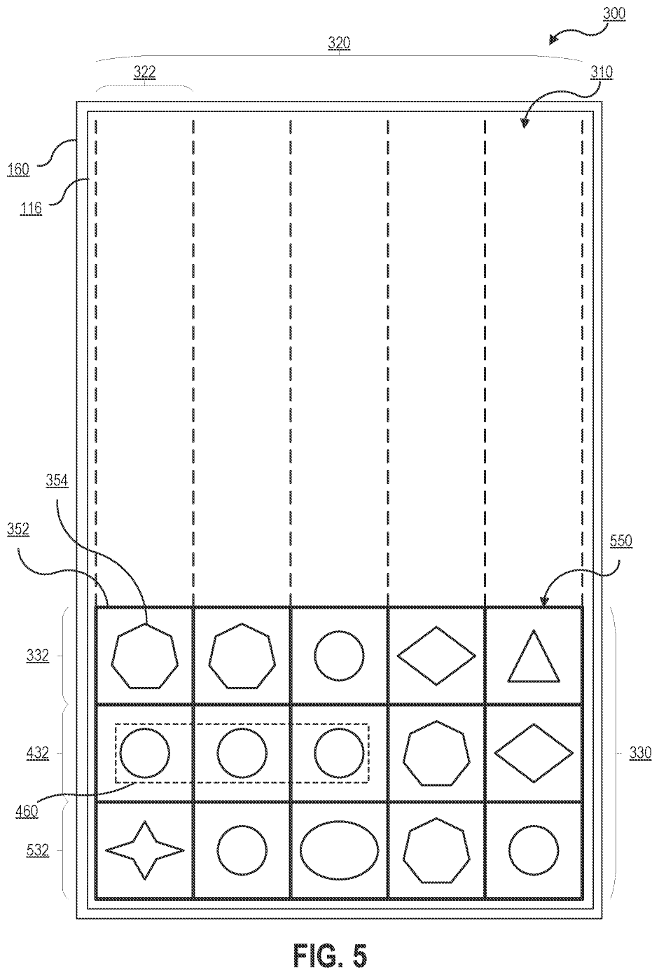

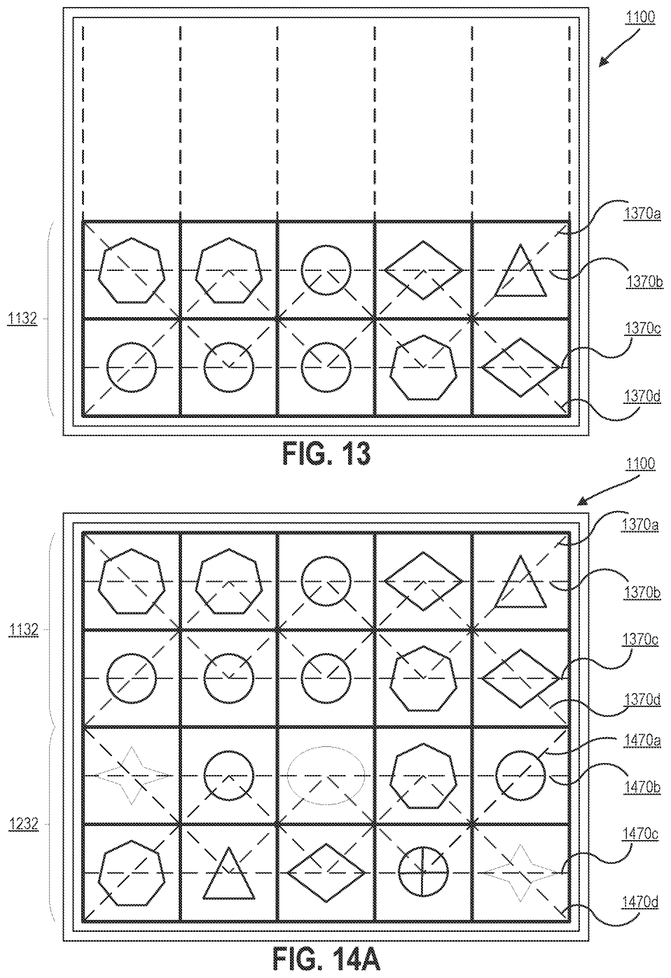

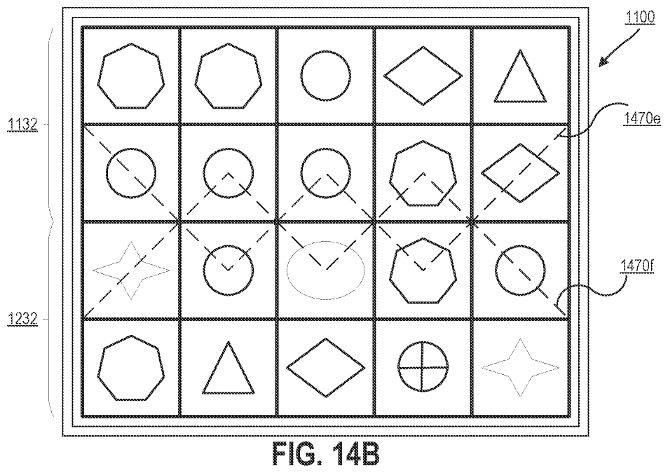

In FIG. 4, row 432 includes a new set of slot symbols 354 including a winning combination of symbols 460. In this example, the winning combination of symbols 460 includes three circles within the same row. In some embodiments, the types of winning combination can be predetermined based on the slot game and each type of winning combination can be associated with a specific prize that can be awarded to the player of the wagering game. Winning combinations can be based on specific number of like or unique symbols along a payline (e.g., paylines 1370a-d and 1470a-f in FIGS. 13-14B). In additional or alternative embodiments, the winning combination of symbols 460 is displayed in a distinguishing manner from the other symbols 354. In some examples, the winning combination of symbols 460 are displayed in a different color, size, or animation than other symbols 354. In additional or alternative examples, the slot reels 352 associated with the winning combination of symbols 460 are displayed in a distinguishing manner from the slot reels 352 associated with the other slot symbols 354. In additional or alternative examples, a box is displayed around the winning combination of symbols 460 or another indicator is used to distinguish the winning combination of symbols 460 from the other symbols 354. In additional or alternative embodiments, the winning combination of symbols 460 is displayed in the distinguishing manner or in another distinguishing manner in subsequent grids (e.g., grids 550, 650, 750, 850, and 950b of FIGS. 5-8 and 10). In some examples, the winning combination of symbols 460 is continued to be displayed in a distinguishing manner to remind a player (or indicate to a new player) that the winning combination of symbols 460 will continue to payout (or will be available to payout) in subsequent play of the wagering game (as further described below).

In some embodiments, since the grid 450 includes a winning combination of symbols (winning combination of symbols 460) a prize may be awarded to a player of the wagering game 300 in response to displaying the grid 450 on the GUI 310.

In FIG. 5, the GUI 310 displays a grid 550 that includes row 332, row 432, and row 532 that each include slot reels 352 having slot symbols 354. In some embodiments, FIG. 5 has the same relationship to FIG. 4 that FIG. 4 has to FIG. 3. For example, FIG. 5 can illustrate an example of a subsequent playing of the wagering game 300 compared to FIG. 4 or a later stage of playing the wagering game 300.

In FIG. 5, rows 332, 432 maintain the same slot symbols as previously displayed (e.g., in FIGS. 3-4). In additional or alternative examples, rows 332, 432 maintain at least a portion of the same slot symbols 354 as previously displayed. In this example, rows 332, 432 are positioned higher in the GUI 310 in FIG. 5 than FIG. 4. In addition, in FIG. 5, row 532 is positioned at the same position within the GUI 310 that row 432 is positioned in FIG. 4 (and row 332 is positioned in FIG. 3). In additional or alternative examples, rows 332, 432 may remain in the same position within the GUI 310 and row 532 may be positioned higher in the GUI 310.

In some embodiments, since the grid 550 includes a winning combination of symbols (winning combination of symbols 460) a prize may be awarded to a player of the wagering game 300 in response to displaying the grid 550 on the GUI 310. In additional or alternative embodiments, the prize awarded based on the winning combination of symbols 460 may be further based on a number of grids (e.g., grids 350, 450, 550) that the winning combination of symbols 460 has been displayed in. In some examples, the prize associated with the winning combination of symbols 460 can grow in response to having been a part of previous grids. In additional or alternative examples, the prize associated with the winning combination of symbols 460 can decrease in response to having been a part of previous grids. In additional or alternative examples, the distinguishing manner in which the winning combination of symbols 460 is displayed can change based on the number of previous grids for which the winning combination of symbols 460 has been a part of.

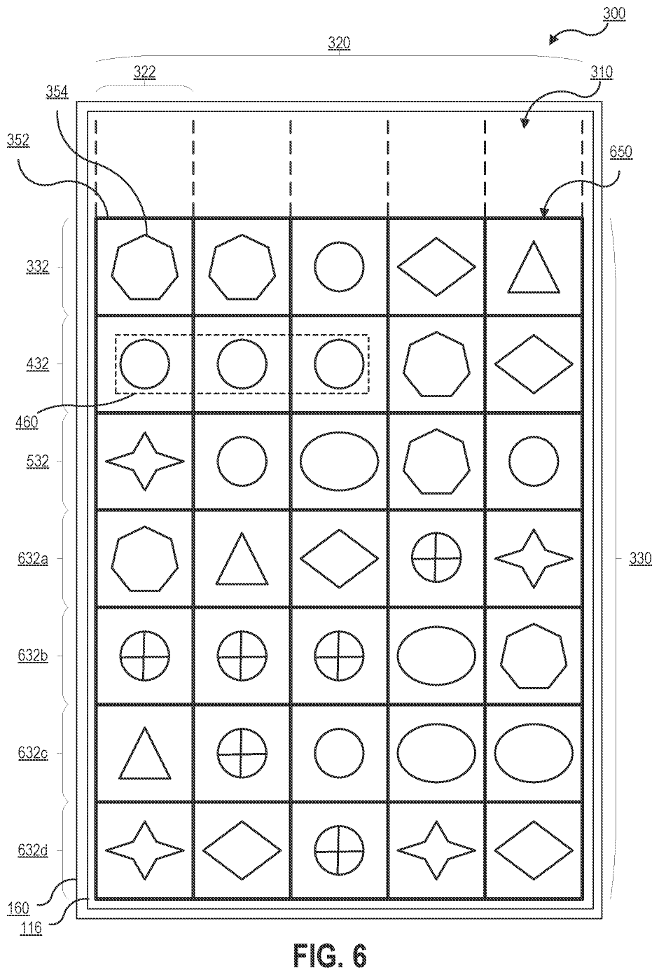

In FIG. 6, the GUI 310 displays a grid 650 that includes row 332, row 432, row 532, and rows 632a-d that each include slot reels 352 having slot symbols 354. In some embodiments, FIG. 6 has a similar relationship to FIG. 5 that FIG. 5 has to FIG. 4. For example, FIG. 6 can illustrate an example of a subsequent playing of the wagering game 300 compared to FIG. 5 or a later stage of playing the wagering game 300.

In FIG. 6, rows 332, 432, 532 maintain the same slot symbols as previously displayed (e.g., in FIGS. 3-5). In additional or alternative examples, rows 332, 432, 532 maintain at least a portion of the same slot symbols 354 as previously displayed. In this example, rows 332, 432, 532 are positioned higher in the GUI 310 in FIG. 6 than FIG. 5. In addition, in FIG. 6, rows 632d is positioned at the same position within the GUI 310 that row 532 is positioned in FIG. 5. In additional or alternative examples, rows 332, 432, 532 may remain in the same position within the GUI 310 and rows 632a-d may be positioned higher in the GUI 310.

In some embodiments, since the grid 450 includes a winning combination of symbols (winning combination of symbols 460) a prize may be awarded to a player of the wagering game 300 in response to displaying the grid 650 on the GUI 310. As described above, the winning combination of symbols 460 in row 432 may continue to be displayed in a distinguishing manner compared to other slot symbols 354. In some embodiments, FIG. 6 may include additional winning combinations of symbols (e.g., the three circled crosses in row 632b may be a winning combination of symbols and/or the three circled crosses diagonally across rows 632b-d may be a winning combination of symbols) that may be displayed in the same distinguishing manner or in a different distinguishing manner. In additional or alternative embodiments, if the grid 650 includes additional winning combination of symbols additional prizes may be awarded to a player of the wagering game 300 in response to displaying the grid 650 on the GUI 310.

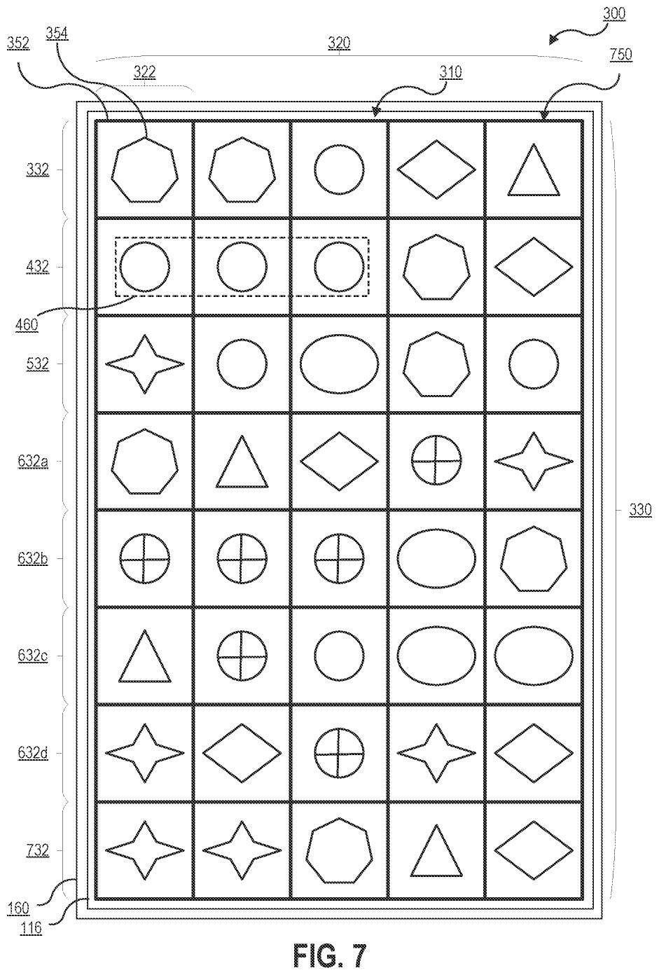

In FIG. 7, the GUI 310 displays a grid 750 that includes row 332, row 432, row 532, rows 632a-d, and row 732 that each include slot reels 352 having slot symbols 354. In some embodiments, FIG. 7 has the same relationship to FIG. 6 that FIG. 5 has to FIG. 4. For example, FIG. 7 can illustrate an example of a subsequent playing of the wagering game 300 compared to FIG. 6 or a later stage of playing the wagering game 300.

In FIG. 7, rows 332, 432, 532, and 632a-d maintain the same slot symbols as previously displayed (e.g., in FIGS. 3-6). In additional or alternative examples, rows 332, 432, 532, 632a-d maintain at least a portion of the same slot symbols 354 as previously displayed. In this example, rows 332, 432, 532, 632a-d are positioned higher in the GUI 310 in FIG. 7 than FIG. 6. In addition, in FIG. 7, rows 732 is positioned at the same position within the GUI 310 that row 532 is positioned in FIG. 5. In additional or alternative examples, rows 332, 432, 532, 632a-d may remain in the same position within the GUI 310 and row 732 may be positioned higher in the GUI 310.

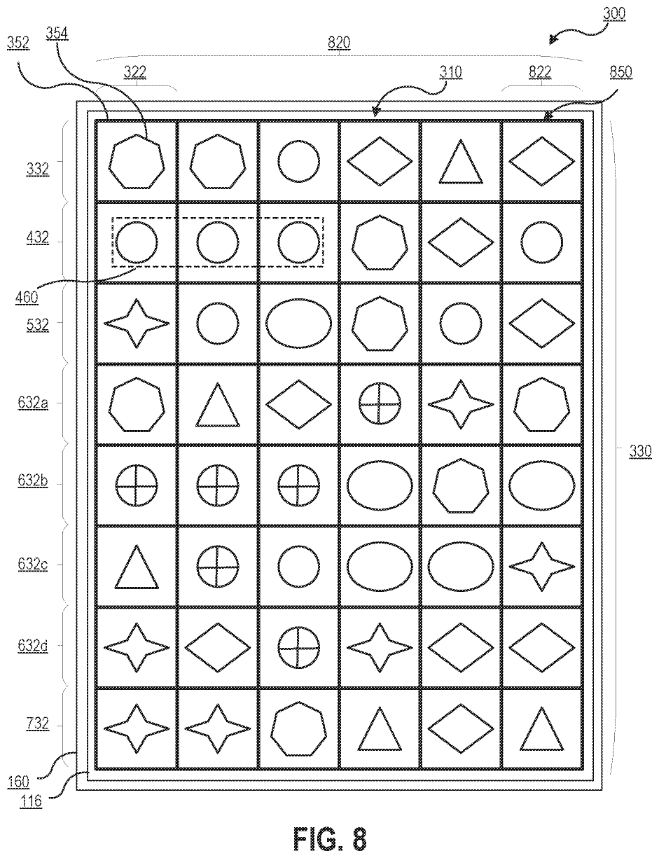

In some embodiments, FIG. 8 illustrates an example of a bonus round associated with the wagering game 300 in which the GUI 310 displays a grid 850 that includes rows 332, 432, 532, 632a-d, 732 with an additional column 822 of slot reels 352 including slot symbols 354 added to each row. In some examples, the bonus round occurs in response to a grid including a threshold number of rows 330. In additional or alternative examples, the bonus round occurs in response to a grid including a specific slot symbol 354 or a specific combination of slot symbols 354.

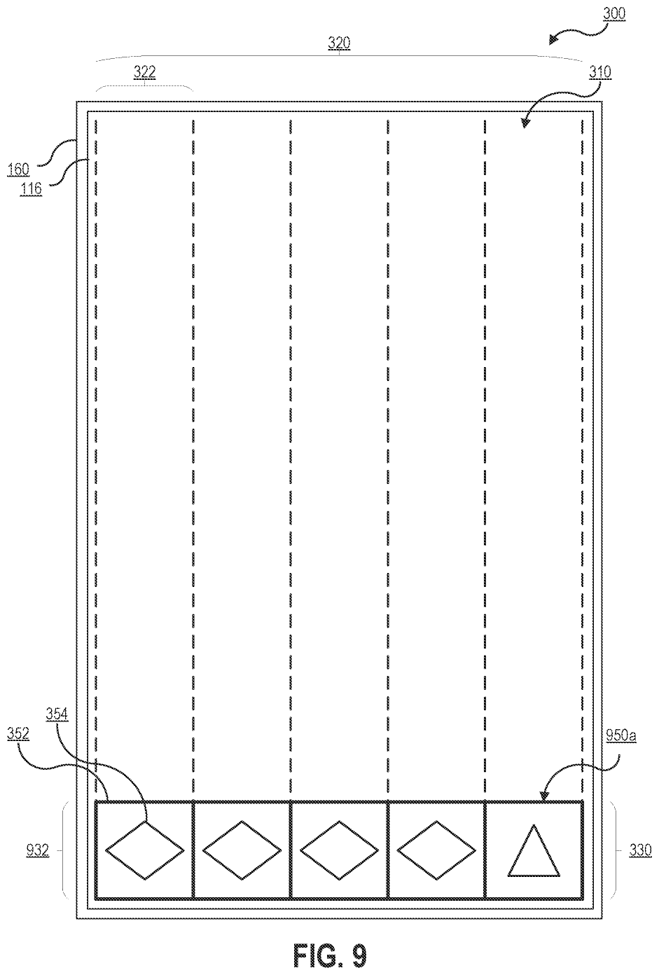

In some embodiments, FIG. 9 illustrates an example of a grid 950a after a grid reaches a threshold number of rows 330 or after the bonus round of FIG. 8. In FIG. 9, the GUI 310 displays a grid 950a that includes a row 932 that includes slot reels 352 having slot symbols 354. Grid 950a does not include any previous rows (e.g., rows 332, 432, 532, 632a-d, 732). In some embodiments, FIG. 9 illustrates an example of starting over the wagering game 300.

In additional or alternative embodiments, FIG. 7 illustrates an example of the grid 750 displayed by the GUI 310 during a first play of the wagering game 300 and FIG. 9 illustrates an example of the grid 950a displayed by the GUI 310 during a subsequent play of the wagering game 300. For example, FIG. 7 may illustrate the grid 750 after a user activated the wagering game 300 with a wager and FIG. 9 may illustrate the grid 950a after the user (or another user) activated the wagering game 300 a subsequent time with a subsequent wager. In additional or alternative embodiments, FIG. 7 illustrates the grid 750 displayed by the GUI 310 during a first stage of the wagering game 300 and FIG. 9 illustrates an example of the grid 950a displayed by the GUI 310 during a second stage of the wagering game 300. For example, FIG. 7 may illustrate the grid 750 a period of time after a user activated the wagering game 300 with a wager and FIG. 9 may illustrate the grid 950a a subsequent period of time after the user activated the wagering game with the wager.

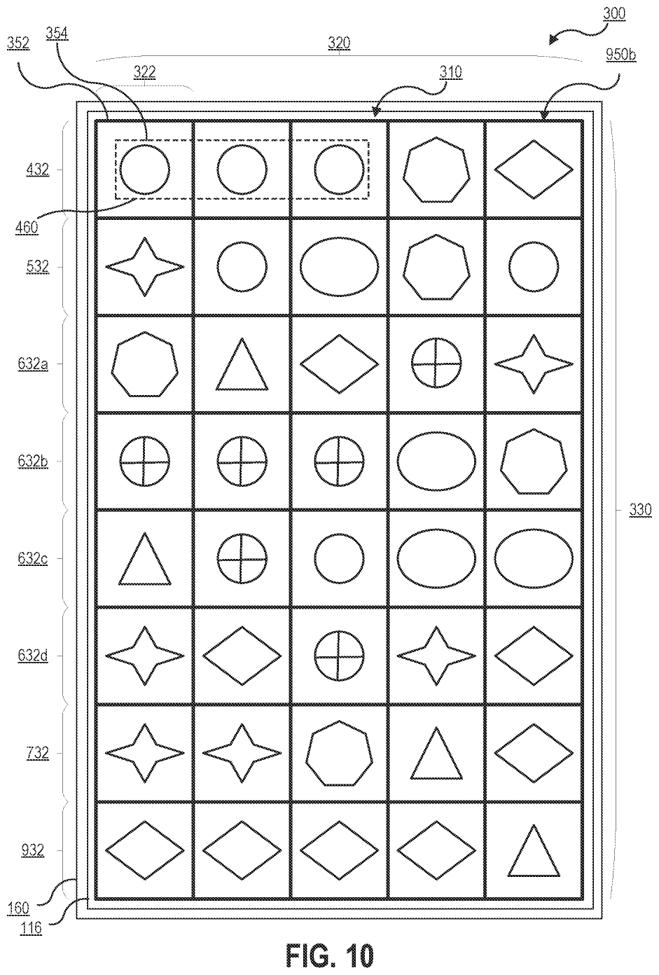

In some embodiments, FIG. 10 illustrates an example of a grid 950b after the grid 750 of FIG. 7 or after the bonus round of FIG. 8. In FIG. 10, the GUI 310 displays a grid 950b that includes rows 432, 532, 632a-d, 732, and 932 including slot reels 352 having slot symbols 354. Grid 950b does not include rows that have been displayed in a threshold number of previous grids (e.g., grid 950b does not include row 332).

In additional or alternative embodiments, FIG. 7 illustrates an example of the grid 750 displayed by the GUI 310 during a first play of the wagering game 300 and FIG. 10 illustrates an example of the grid 950b displayed by the GUI 310 during a subsequent play of the wagering game 300. For example, FIG. 7 may illustrate the grid 750 after a user activated the wagering game 300 with a wager and FIG. 10 may illustrate the grid 950b after the user (or another user) activated the wagering game 300 a subsequent time with a subsequent wager. In additional or alternative embodiments, FIG. 7 illustrates the grid 750 displayed by the GUI 310 during a first stage of the wagering game 300 and FIG. 10 illustrates an example of the grid 950b displayed by the GUI 310 during a second stage of the wagering game 300. For example, FIG. 7 may illustrate the grid 750 a period of time after a user activated the wagering game 300 with a wager and FIG. 10 may illustrate the grid 950b a subsequent period of time after the user activated the wagering game with the wager.

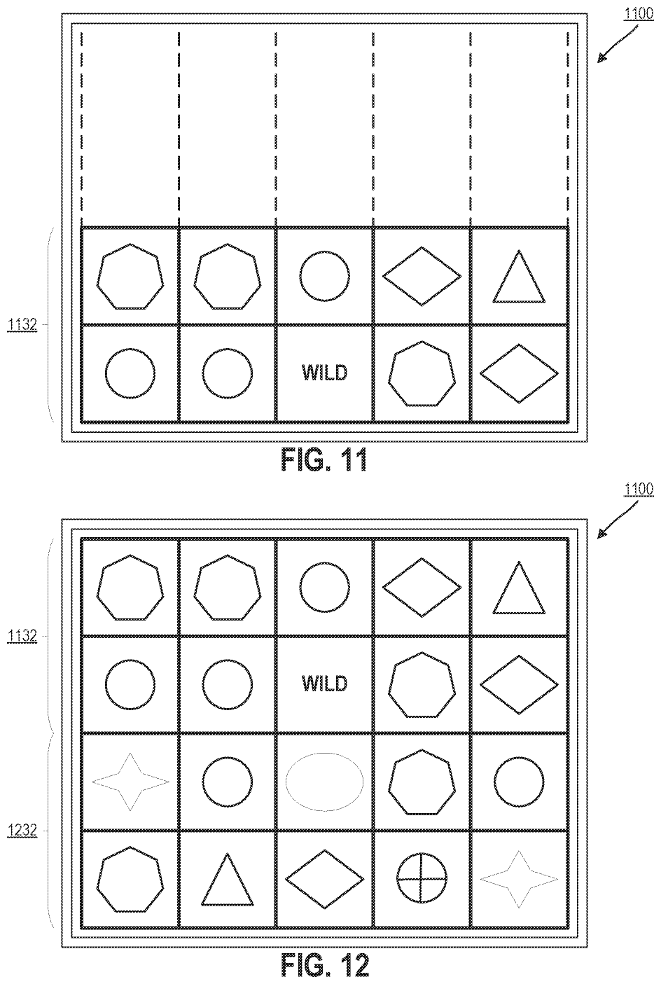

Referring now to FIGS. 11-14B, an EGM 160 providing a wagering game 300 is illustrated, according to some embodiments. In this embodiment, the EGM 160 includes a display device 116 for displaying a graphical user interface (GUI) 310. In these examples, the wagering game 300 is a slot game that includes the GUI 310 displaying an array 350 (also referred to herein as a grid) defined by columns 320 and rows 330 of slot reels 352 that each have a slot symbol 354 associated with the slot game.

Although FIGS. 3-10 illustrate an example of a build-a-slot feature of a wagering game in which a single row is added/changed in subsequent plays (and or stages) of a wagering game, other implementations are possible. In some embodiments, a wagering game includes a build-a-slot feature in which more than one row is added/changed in subsequent plays (and or stages) of a wagering game. In additional or alternative embodiments, only a portion (e.g., a row, column, predetermined pattern, or random pattern) of slot symbols are maintained between subsequent plays (and or stages) of a wagering game.

In some examples, a 5×5 grid of symbols is displayed in a first playthrough of a wagering game in response to a first wager. In a second playthrough of the wagering game (in response to a second wager), 5 of the symbols in the original 5×5 grid are changed. In each of a third, fourth, and fifth playthrough of the wagering game (in response to a third, fourth, and fifth wager respectively) 5 more of the symbols in the original 5×5 grid are changed such that in the fifth playthrough the displayed grid is not based on any of the symbols in the original 5×5 grid.

FIGS. 11-14B illustrate an example of a wagering game 1100 similar to wagering game 300 of FIGS. 3-10 that includes a slot game and has a build-a-slot feature in which two rows are displayed in a first playthrough (or stage) and four rows are displayed in a second playthrough (or stage). In other examples, four rows are displayed in a first playthrough and two of the rows are changed in a second playthrough.

FIG. 11 illustrates a first play (and/or a first stage) of the wagering game 1100 in which a grid is displayed having a first set 1132 of two rows of slot reels and slot symbols. FIG. 12 illustrates a second play (or a second stage) of the wagering game 1100 in which a grid is displayed having the first set 1132 and a second set 1232 of two rows of slot reels and slot symbols.

In some embodiments, a specific symbol displayed in a grid of the wagering game may not be triggered until the grid includes a threshold number of rows (or symbols). For example, the “WILD” symbol in set 1132 may not be used in determining any winning combination of symbols until (as illustrated in FIG. 12) the grid is full.

FIGS. 13 and 14A-B illustrate the wagering game 1100 of FIGS. 11-12 and further illustrate the paylines 1370a-d, 1470a-f available during different playthroughs (or stages) of the wagering game 1100. FIG. 13 illustrates that in a first playthrough of the wagering game 1100, only paylines 1370a-d associated with set 1132 may be activated for determining winning combinations of symbols. FIG. 14A illustrates that in a second playthrough of the wagering game 1100, paylines 1370a-d associated with set 1132 and paylines 1470a-d associated with set 1232 may be activated for determining winning combinations of symbols. FIG. 14B illustrates that in the second playthrough of the wagering game 1100, cross-set paylines 1470e-f associated with set 1132 and set 1232 may be activated for determining winning combinations of symbols. In some examples, cross-set paylines may only be activated in response to a trigger event, a wager size, and/or the grid including a threshold number of rows/sets/symbols.

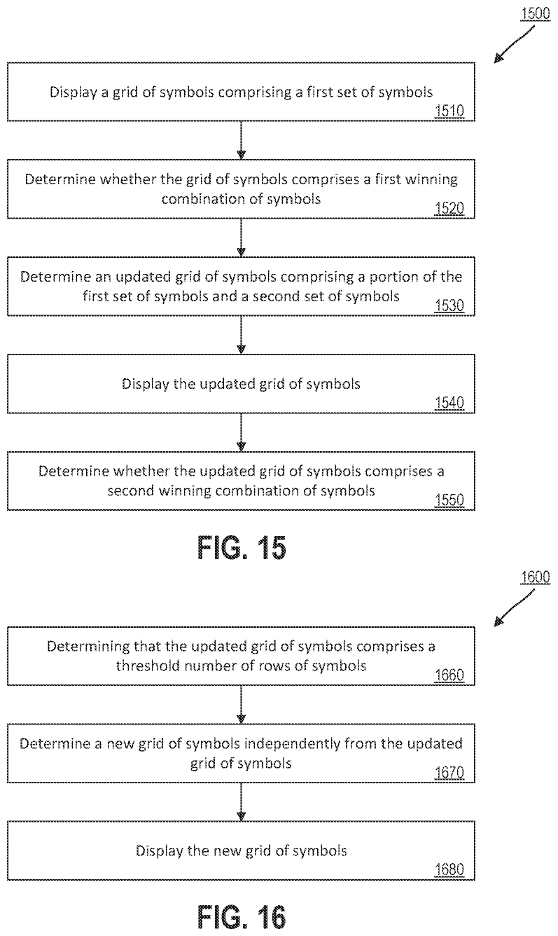

FIG. 15 is a flowchart illustrating operations 1500 of systems/methods for facilitating embodiments described herein. The operations 1500 may include displaying a grid of symbols including a first set of symbols (Block 1510).

The operations 1500 may further include determining whether the grid of symbols include a first winning combination of symbols (Block 1520). In some embodiments, determining whether the grid of symbols includes the first winning combination of symbols includes determining whether a first row of symbols includes a single-way winning combination of symbols.

The operations 1500 may further include determining an updated grid of symbols comprising a portion of the first set of symbols and a second set of symbols (Block 1530). In some embodiments, the first set of symbols includes a first row of symbols; the portion of the first set of symbols includes the first row of symbols; and the second set of symbols includes a second row of symbols. In additional or alternative embodiments, the first set of symbols includes multiple rows of symbols and the portion of the first set of symbols includes the multiple rows of symbols. In additional or alternative embodiments, the first set of symbols includes multiple rows of symbols and the portion of the first set of symbols includes one row of symbols of the multiple rows of symbols.

The operations 1500 may further include displaying the updated grid of symbols (Block 1540). In some embodiments, displaying the updated grid of symbols includes displaying the second set of symbols in a distinguishing manner from the portion of the first set of symbols. In additional or alternative embodiments, displaying the updated grid of symbols includes, responsive to determining that the grid of symbols includes the first winning combination of symbols, determining whether the updated grid of symbols includes the first winning combination of symbols and responsive to determining that the updated grid of symbols includes the first winning combination of symbols, displaying the first winning combination of symbols in a distinguishing manner from other symbols in the updated grid of symbols.

The operations 1500 may further include determining whether the updated grid of symbols includes a second winning combination of symbols (Block 1550). In some embodiments, determining whether the updated grid of symbols includes a second winning combination of symbols comprises determining whether a first row of symbols and a second row of symbols include a multi-way winning combination of symbols.

FIG. 16 is a flowchart illustrating operations 1600 of systems/methods for facilitating embodiments described herein. The operations 1600 may include determining that the updated grid of symbols includes a threshold number of rows of symbols (Block 1660).

The operations 1600 may further include determining a new grid of symbols independently from the updated grid of symbols (Block 1670).

The operations 1600 may further include displaying the new grid of symbols (Block 1680).

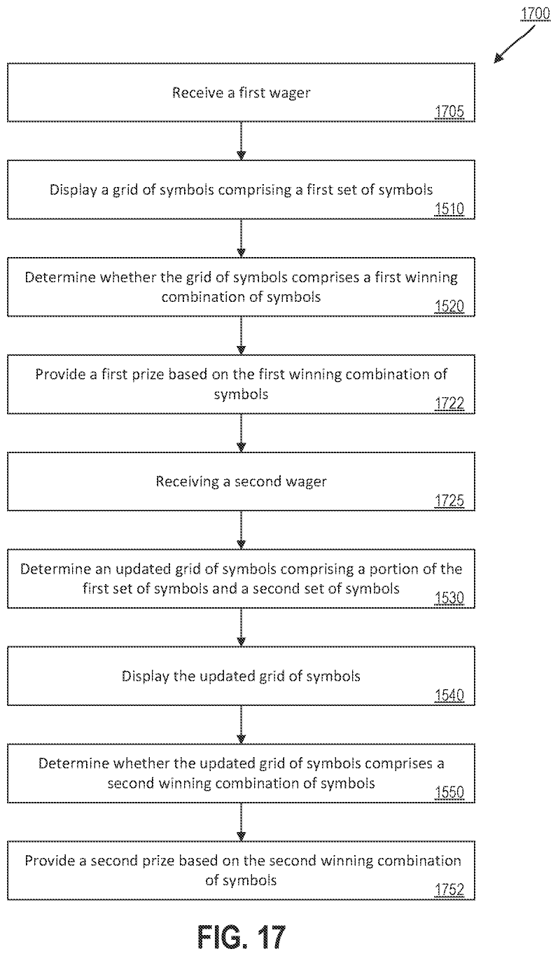

FIG. 17 is a flowchart illustrating operations 1700 of systems/methods for facilitating embodiments described herein. The operations 1700 may include receiving a first wager (Block 1705). For example, in some embodiments, a wager for any of the wagering games 300, 1100 of FIGS. 3-14B above may be received at the EGM 160 or another gaming device 100, via input devices 130, game play initiation button 132, or touchscreen display device 116. The operations 1700 may further include, responsive to receiving the first wager, displaying the grid of symbols including the first set of symbols and determining whether the grid of symbols include a first winning combination of symbols (Blocks 1510 and 1520 of FIG. 15).

The operations 1700 may further include providing a first prize based on the first winning combination of symbols (Block 1722). For example, an award indication may be displayed on a display screen 116 of the EGM 160 or other gaming device 100, printed on a ticket generated by a ticket server 90, and/or any number of other types of indications, as desired.

The operations 1700 may further include receiving a second wager (Block 1725). For example, in some embodiments, a wager for any of the wagering games 300, 1100 of FIGS. 3-14B above may be received at the EGM 160 or another gaming device 100, via input devices 130, game play initiation button 132, or touchscreen display device 116. The operations 1700 may further include, responsive to receiving the second wager, determining an updated grid of symbols including a portion of the first set of symbols and a second set of symbols; displaying the updated grid of symbols; and determining whether the updated grid of symbols includes a second winning combination of symbols (Blocks 1530, 1540, 1550 of FIG. 15).

The operations 1700 may further include providing a second prize based on the second winning combination of symbols (Block 1752). For example, an award indication may be displayed on a display screen 116 of the EGM 160 or other gaming device 100, printed on a ticket generated by a ticket server 90, and/or any number of other types of indications, as desired.

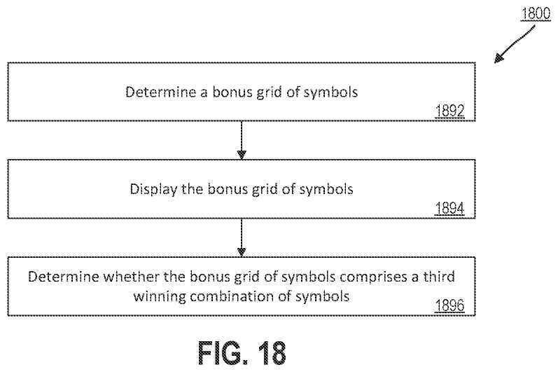

FIG. 18 is a flowchart illustrating operations 1800 of systems/methods for facilitating embodiments described herein. The operations 1800 may include determining a bonus grid of symbols (Block 1892).

The operations 1800 may further include displaying the bonus grid of symbols (Block 1894).

The operations 1800 may further include determining whether the bonus grid of symbols includes a third winning combination of symbols (Block 1896).

Embodiments described herein may be implemented in various configurations for gaming devices 100, including but not limited to: (1) a dedicated gaming device, wherein the computerized instructions for controlling any games (which are provided by the gaming device) are provided with the gaming device prior to delivery to a gaming establishment; and (2) a changeable gaming device, where the computerized instructions for controlling any games (which are provided by the gaming device) are downloadable to the gaming device through a data network when the gaming device is in a gaming establishment. In some embodiments, the computerized instructions for controlling any games are executed by at least one central server, central controller or remote host. In such a “thin client” embodiment, the central server remotely controls any games (or other suitable interfaces) and the gaming device is utilized to display such games (or suitable interfaces) and receive one or more inputs or commands from a player. In another embodiment, the computerized instructions for controlling any games are communicated from the central server, central controller or remote host to a gaming device local processor and memory devices. In such a “thick client” embodiment, the gaming device local processor executes the communicated computerized instructions to control any games (or other suitable interfaces) provided to a player.

In some embodiments, a gaming device may be operated by a mobile device, such as a mobile telephone, tablet other mobile computing device. For example, a mobile device may be communicatively coupled to a gaming device and may include a user interface that receives user inputs that are received to control the gaming device. The user inputs may be received by the gaming device via the mobile device.

In some embodiments, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more gaming devices; and/or (c) one or more personal gaming devices, such as desktop computers, laptop computers, tablet computers or computing devices, PDAs, mobile telephones such as smart phones, and other mobile computing devices.

In certain such embodiments, computerized instructions for controlling any games (such as any primary or base games and/or any secondary or bonus games) displayed by the gaming device are executed by the central server, central controller, or remote host. In such “thin client” embodiments, the central server, central controller, or remote host remotely controls any games (or other suitable interfaces) displayed by the gaming device, and the gaming device is utilized to display such games (or suitable interfaces) and to receive one or more inputs or commands. In other such embodiments, computerized instructions for controlling any games displayed by the gaming device are communicated from the central server, central controller, or remote host to the gaming device and are stored in at least one memory device of the gaming device. In such “thick client” embodiments, the at least one processor of the gaming device executes the computerized instructions to control any games (or other suitable interfaces) displayed by the gaming device.

In some embodiments in which the gaming system includes: (a) a gaming device configured to communicate with a central server, central controller, or remote host through a data network; and/or (b) a plurality of gaming devices configured to communicate with one another through a data network, the data network is an internet or an intranet. In certain such embodiments, an internet browser of the gaming device is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the gaming device, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the internet browser of the gaming device.

It should be appreciated that the central server, central controller, or remote host and the gaming device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of gaming devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In the above-description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product including one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (“RF”), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, Common Business Oriented Language (“COBOL”) 2002, PHP: Hypertext Processor (“PHP”), Advanced Business Application Programming (“ABAP”), dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processing circuit of a general purpose computer, special purpose computer, or other programmable data processing apparatus to produce a machine, such that the instructions, which execute via the processing circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

1. A gaming system comprising:
a processor circuit;
a memory coupled to the processor circuit, the memory comprising machine-readable instructions that, when executed by the processor circuit, cause the processor circuit to perform operations comprising:
displaying, via a graphical interface, a grid of symbols comprising a first set of symbols;
determining whether the grid of symbols comprises a first winning combination of symbols;
determining an updated grid of symbols comprising a portion of the first set of symbols and a second set of symbols, the updated grid of symbols including more symbols than the grid of symbols;
displaying, via the graphical interface, the updated grid of symbols instead of the grid of symbols; and
determining whether the updated grid of symbols comprises a second winning combination of symbols.

2. The system of claim 1, wherein the first set of symbols comprises a first row of symbols,
wherein the portion of the first set of symbols comprises the first row of symbols, and
wherein the second set of symbols comprises a second row of symbols.

3. The system of claim 2, wherein the first set of symbols comprises multiple rows of symbols, and
wherein the portion of the first set of symbols comprises the multiple rows of symbols.

4. The system of claim 2, wherein determining whether the grid of symbols comprises the first winning combination of symbols comprises determining whether the first row of symbols comprises a single-way winning combination of symbols,
wherein determining whether the updated grid of symbols comprises the second winning combination of symbols comprises:
determining that the updated grid of symbols comprises a threshold number of rows of symbols; and
responsive to determining that the updated grid of symbols comprises the threshold number of rows of symbols, determining whether a combination of the first row of symbols and the second row of symbols comprise any single-way winning combination of symbols and any multi-way winning combination of symbols.

5. The system of claim 2, the operations further comprising:
responsive to determining whether the updated grid of symbols comprises the second winning combination of symbols, determining that the updated grid of symbols comprises a threshold number of rows of symbols;
responsive to determining that the updated grid of symbols comprises the threshold number of rows of symbols, determining a new grid of symbols independently from the updated grid of symbols, the new grid of symbols comprising fewer rows of symbols than the threshold number of rows of symbols; and
displaying, via the graphical interface, the new grid of symbols instead of the updated grid of symbols.

6. The system of claim 2, wherein determining whether the grid of symbols comprises the first winning combination of symbols comprises determining whether the first row of symbols comprises a single-way winning combination of symbols, and
wherein determining whether the updated grid of symbols comprises a second winning combination of symbols comprises determining whether the first row of symbols and the second row of symbols comprise a multi-way winning combination of symbols.

7. The system of claim 6, wherein determining whether the first row of symbols and the second row of symbols comprise the multi-way winning combination of symbols comprises:
determining whether the first row of symbols comprises a first single-line winning combination of symbols;
determining whether the second row of symbols comprises a second single-line winning combination of symbols; and
determining whether the first row of symbols and the second row of symbols comprise a multi-line winning combination of symbols.

8. The system of claim 1, wherein displaying the updated grid of symbols comprises displaying the second set of symbols in a distinguishing manner from the portion of the first set of symbols.

9. The system of claim 1, wherein displaying the updated grid of symbols comprises:
responsive to determining that the grid of symbols comprises the first winning combination of symbols, determining whether the updated grid of symbols comprises the first winning combination of symbols; and
responsive to determining that the updated grid of symbols comprises the first winning combination of symbols, displaying the first winning combination of symbols in a distinguishing manner from other symbols in the updated grid of symbols.

10. The system of claim 1, wherein the second winning combination of symbols comprises the first winning combination of symbols.

11. The system of claim 1, the operations further comprising:
receiving a first wager prior to displaying the grid of symbols; and
receiving a second wager prior to determining the updated grid of symbols,
wherein displaying the grid of symbols comprises displaying the grid of symbols in response to receiving the first wager, and
wherein determining the updated grid of symbols comprises displaying the updated grid of symbols in response to receiving the second wager.

12. The system of claim 1, the operations further comprising:
responsive to determining that the grid of symbols comprises the first winning combination of symbols, providing a first prize based on the first winning combination of symbols; and
responsive to determining that the updated grid of symbols comprises the second winning combination of symbols, providing a second prize based on the second winning combination of symbols.

13. The system of claim 1, wherein determining whether the updated grid of symbols comprises the second winning combination of symbols comprises:
determining that the updated grid of symbols comprises a threshold number of rows of symbols; and
determining whether the updated grid of symbols comprises the second winning combination of symbols based on determining that the updated grid of symbols comprises the threshold number of rows of symbols.

14. The system of claim 13, wherein determining whether the updated grid of symbols comprises the second winning combination of symbols comprises:
evaluating bonus symbols in the portion of the first set of symbols in response to determining that the updated grid of symbols comprises a threshold number of rows of symbols.

15. The system of claim 1, the operations further comprising:
responsive to a trigger, determining a bonus grid of symbols by adding an additional symbol to each set of symbols in the grid of symbols;
displaying, via the graphical interface, the bonus grid of symbols; and
determining whether the bonus grid of symbols comprises a third winning combination of symbols.

16. A computer-implemented method of operating a gaming device, the method comprising:
displaying, to a user and via a display device of the gaming device, a grid of symbols that comprises a first set of symbols;
receiving a wager from the user;
displaying, to the user and via the display device of the gaming device, an updated grid of symbols that comprises the first set of symbols and a second set of symbols, the updated grid of symbols including more symbols than the grid of symbols; and
providing to the user a prize based on the updated grid of symbols comprising a winning combination of symbols.

17. The computer-implemented method of claim 16, wherein the user is a second user, the wager is a second wager, the prize is a second prize, and the winning combination is a second winning combination,
the method further comprising:
receiving a first wager from a first user;
subsequent to receiving the first wager from the first user, displaying to the first user and via the display device of the gaming device, the grid of symbols that comprises the first set of symbols; and
providing the first user a first prize based on the grid of symbols comprising a first winning combination
wherein receiving the second wager from the second user comprises, subsequent to providing the first user the first prize, receiving the second wager from the second user.

18. The computer-implemented method of claim 17, further comprising:
responsive to providing the second user the second prize, determining that the updated grid of symbols comprises a threshold number of symbols;
receiving a third wager from a third user; and
responsive to determining that the updated grid of symbols comprises the threshold number of symbols and receiving the third wager from the third user, displaying, to the third user and via the display device of the gaming machine, a new grid of symbols that is independent from the updated grid of symbols instead of the updated grid of symbols.

19. A gaming device comprising:
a display device;
a processor circuit; and
a memory coupled to the processor circuit, the memory comprising machine-readable instructions that, when executed by the processor circuit, cause the processor circuit to perform operations comprising:
determining a first set of symbols in a grid of symbols being displayed on the display device; and
determining a new grid of symbols that comprises a portion of the first set of symbols and a second set of symbols, the new grid of symbols including more symbols than the grid of symbols;
displaying the new grid of symbols on the display device instead of the grid of symbols.

20. The gaming device of claim 19, the operations further comprising:
receiving a first wager from a user;
responsive to receiving the first wager, determining the grid of symbols;
responsive to receiving the first wager, displaying the grid of symbols on the display device;
responsive to receiving the first wager, determining whether the grid of symbols comprises a first winning combination of symbols;
receiving a second wager from the user; and
responsive to receiving the second wager, determining whether the new grid of symbols comprises a second winning combination of symbols.
